(19) United States
(12) Patent Application Publication
(10) Pub. No.: US 2013/0027582 A1
(43) Pub. Date: Jan. 31, 2013

(54) ELECTRONIC CAMERA

(71) Applicant: Akira Okasaka, Osaka-shi (JP)

(72) Inventor: Akira Okasaka, Osaka-shi (JP)

(73) Assignee: SANYO ELECTRIC CO., LTD., Osaka (JP)

(21) Appl. No.: 13/556,476

(22) Filed: Jul. 24, 2012

(30) Foreign Application Priority Data
Jul. 27, 2011 (JP) 2011-163814

(51) Int. Cl. H04N 5/76

(52) U.S. Cl. 348/231.99; 348/E05.024

(57) ABSTRACT

An electronic camera includes a recorder. A recorder records an image outputted from an imager in response to a recording operation. An assigner assigns an imaging direction at a time of accepting the recording operation to the image recorded by the recorder. An extractor executes a process for extracting one portion of images having a common imaging position from among a plurality of the images recorded by the recorder in response to a reproducing operation. An acceptor accepts a direction-designating operation in association with the extracting process of the extractor. A reproducer reproduces an image, to which an imaging direction equivalent to a direction designated by the direction-designating operation is assigned, among one the portion of images extracted by the extractor.

### CROSS REFERENCE OF RELATED APPLICATION

The disclosure of Japanese Patent Application No. 2011-163814 which was filed on Jul. 27, 2011, is incorporated herein by reference.

### BACKGROUND OF THE INVENTION

1. Field of the Invention

The present invention relates to an electronic camera, and more particularly, the present invention relates to an electronic camera which reproduces a plurality of images having a common imaging position in association with one another.

2. Description of the Related Art

According to one example of this type of camera, an optical image is converted into an electrical signal by an imager. A photographed image by the imager is sequentially stored in a first image memory processor provided with a storage capacity corresponding to at least two screens. In a second image memory processor, an image that undergoes a combining process is stored. A new image portion is detected by an arithmetic operation controller, from an image that is inputted later in time, through an arithmetic operation performed between the images stored in the first image memory processor, and is accommodated in the second image memory processor. An image completed on the second image memory processor through the combining process is sequentially recorded on the recording medium. In this way, a series of photographed images are subjected to the combining process, and a plurality of still images each of which partially configures an ultra-wide image are formed and are recorded on the recording medium.

However, in the background technology, the combining process is performed on the plurality of images and then the combined image is recorded, and thus, a plurality of images, which can be reproduced in association with one another, are limited to the plurality of images for which the combining process is performed. Therefore, there is a probability that operability at a time of an image reproduction may deteriorate.

### SUMMARY OF THE INVENTION

An electronic camera according to the present invention, comprises: a recorder which records an image outputted from an imager in response to a recording operation; an assigner which assigns an imaging direction at a time of accepting the recording operation to the image recorded by the recorder, an extractor which executes, in response to a reproducing operation, a process for extracting one portion of images having a common imaging position from among a plurality of the images recorded by the recorder, an acceptor which accepts a direction-designating operation in association with the extracting process of the extractor, and a reproducer which reproduces an image, to which an imaging direction equivalent to a direction designated by the direction-designating operation is assigned, from among the one portion of images extracted by the extractor.

According to the present invention, an image processing program, which is recorded on a non temporary recording medium in order to control an electronic camera including an imager, allowing a processor of the electronic camera to execute: a recording step of recording an image outputted from the imager in response to a recording operation; an assigning step of assigning an imaging direction at a time of accepting the recording operation to the image recorded in the recording step; an extracting step of executing a process for extracting one portion of images having a common imaging position from among a plurality of the images recorded in the recording step in response to a reproducing operation; an accepting step of accepting a direction-designating operation in association with the extracting process of the extracting step; and a reproducing step of reproducing an image, to which an imaging direction equivalent to a direction designated by the direction-designating operation is assigned, from among the one portion of images extracted in the extracting step.

According to the present invention, an image processing method, which is executed by an electronic camera including an imager, comprises: a recording step of recording an image outputted from the imager in response to a recording operation; an assigning step of assigning an imaging direction at a time of accepting the recording operation to the image recorded in the recording step; an extracting step of executing a process for extracting one portion of images having a common imaging position from among a plurality of the images recorded in the recording step in response to a reproducing operation; an accepting step of accepting a direction-designating operation in association with the extracting process of the extracting step; and a reproducing step of reproducing an image, to which an imaging direction equivalent to a direction designated by the direction-designating operation is assigned, from among the one portion of images extracted in the extracting step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a configuration of a register referred to in an imaging task and a current position managing task;

FIG. 4 is an illustrative view showing one example of a plurality of scenes to be recorded in the embodiment in FIG. 2;

FIG. 5 is an illustrative view showing one example of a configuration of the register referred to in the imaging task;

FIG. 6 is an illustrative view showing one example of a configuration of the register referred to in the imaging task and a direction managing task;

FIG. 7 is an illustrative view showing one example of a configuration of an Exif tag created by the embodiment in FIG. 2;

FIG. 8 is an illustrative view showing a recording state of a recording medium used by the embodiment in FIG. 2;

FIG. 9 is an illustrative view showing one example of a configuration of a table referred to in a reproducing task;

FIG. 10 is an illustrative view showing one example of a configuration of the register referred to in the reproducing task;

FIG. 11 is a flowchart showing one portion of an operation of a CPU applied to the embodiment in FIG. 2;

FIG. 12 is a flowchart showing another portion of the operation of the CPU applied to the embodiment in FIG. 2;

FIG. 13 is a flowchart showing still another portion of the operation of the CPU applied to the embodiment in FIG. 2;

FIG. 14 is a flowchart showing yet another portion of the operation of the CPU applied to the embodiment in FIG. 2;

FIG. 15 is a flowchart showing another portion of the operation of the CPU applied to the embodiment in FIG. 2;

FIG. 16 is a flowchart showing still another portion of the operation of the CPU applied to the embodiment in FIG. 2;

FIG. 17 is a flowchart showing yet another portion of the operation of the CPU applied to the embodiment in FIG. 2;

FIG. 18 is a flowchart showing another portion of the operation of the CPU applied to the embodiment in FIG. 2; and

FIG. 19 is a block diagram showing a configuration of another embodiment of the present invention.

### DETAILED DESCRIPTION OF THE PREFERRED EMBODIMENTS

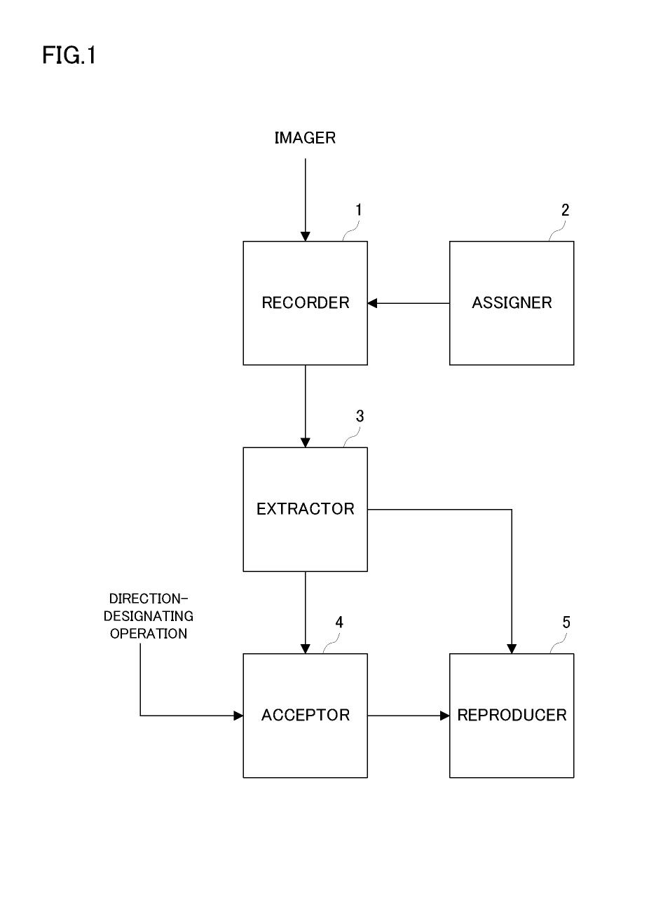

With reference to FIG. 1, an electronic camera according to one embodiment of the present invention is basically configured as follows: A recorder 1 records an image outputted from an imager in response to a recording operation. An assigner 2 assigns an imaging direction at a time of accepting the recording operation to the image recorded by the recorder 1. An extractor 3 executes a process for extracting one portion of images having a common imaging position from among a plurality of the images recorded by the recorder 1 in response to a reproducing operation. An acceptor 4 accepts a direction-designating operation in association with the extracting process of the extractor 3. A reproducer 5 reproduces an image, to which an imaging direction equivalent to a direction designated by the direction-designating operation is assigned, among one the portion of images extracted by the extractor 3.

The imaging direction at a time of accepting the recording operation is assigned to the recorded images. One portion of the images having a common imaging position is extracted from among the plurality of recorded images in response to the reproducing operation. Among one portion of the extracted images, an image, to which the imaging direction equivalent to the direction designated by the direction-designating operation accepted in association with the extracting process is assigned, is reproduced.

As described above, a reproduced image is determined by a combination of the imaging direction assigned to the image and the direction-designating operation. Therefore, it is possible to determine a reproduced image through an operation simpler than a normal selecting operation, and this serves to improve operability at a time of selecting a reproduced image.

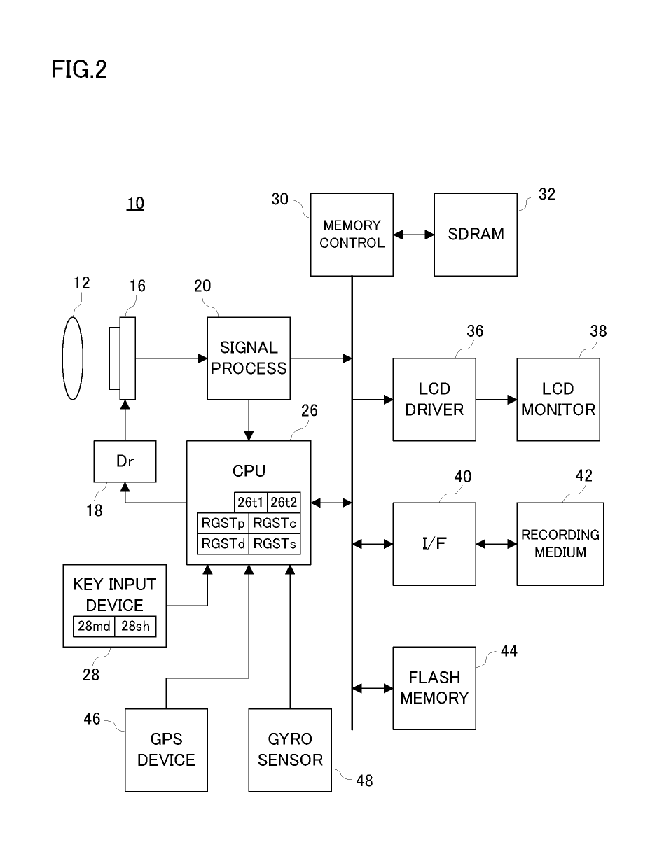

With reference to FIG. 2, a digital camera 10 of the present embodiment includes a focus lens 12 driven by a driver 18. An optical image of a scene that underwent theses members enters, with irradiation, an imaging surface of an image sensor 16, and is subject to a photoelectric conversion. Thereby, electric-charges representing a scene are generated.

If an entire system is activated, a main CPU 26 determines a state (that is, an operation mode at this time point) of a mode change button 28md provided in a key input device 28 under a main task, and activates an imaging task corresponding to an imaging mode while activates a reproducing task corresponding to a reproducing mode.

If the imaging task is activated, in order to execute a moving image taking process, the main CPU 26 instructs the driver 18 to repeat an exposure procedure and an electric-charge reading-out procedure. The driver 18 exposes the imaging surface and reads out the electric-charges, which are generated on the imaging surface, in a raster scanning manner, in response to a vertical synchronization signal Vsync periodically generated from an SG (Signal Generator) (not shown). From the image sensor 16, raw image data based on the read electric-charges is periodically outputted.

A signal processing circuit 20 performs processes such as a white balance adjustment, a color separation, or a YUV conversion on the raw image data outputted from the image sensor 16, and writes YUV-formatted image data generated thereby into an SDRAM 32 through a memory control circuit 30. An LCD driver 36 repeatedly reads out the image data accommodated in the SDRAM 32 through the memory control circuit 30, and drives an LCD monitor 38 based on the read-out image data. As a result, a moving image representing a scene is displayed on a monitor screen.

Y data, out of the image data generated by the signal processing circuit 20, is also applied to the CPU 26. The CPU 26 performs a simple AE process on the applied Y data so as to calculate an appropriate EV value. An aperture amount and an exposure time defining the calculated appropriate EV value are set to the driver 18, and as a result, the brightness of the moving image is moderately adjusted.

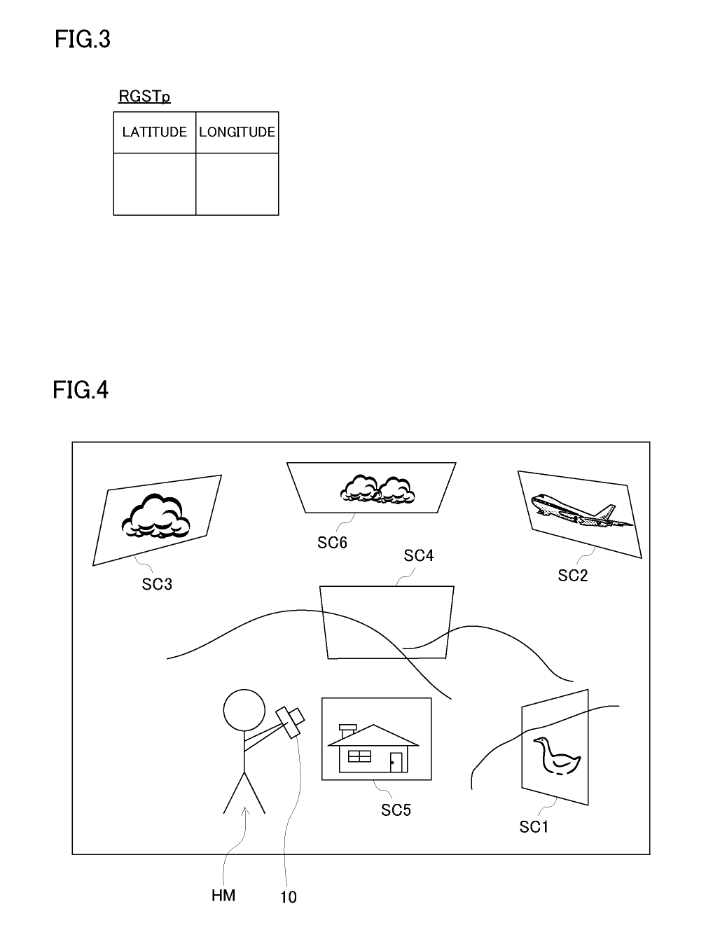

Under a current position managing task executed in parallel with the imaging task, the CPU 26 repeatedly issues a measurement command toward a GPS device 46. The GPS device 46 that receives the measurement command measures a current position with reference to a signal transmitted from a plurality of GPS satellites in the sky, and sends back a measurement result to the CPU 26. The CPU 26 acquires a latitude and a longitude indicating the current position of the digital camera 10, based on the returned measurement result. The acquired latitude and longitude are registered in a current position register RGSTp shown in FIG. 3.

After issuing the measurement command, the CPU 26 executes a reset & a start of a timer 26t1. For example, a timer value is 90 seconds. If a timeout occurs in the timer 26t1, the CPU 26 issues a next measurement command. That is, the measurement command is issued every 90 seconds.

Furthermore, under the current position managing task, when it is not possible to acquire the current position of the digital camera 10 from the returned measurement result, that is, when the measurement of the current position fails, the CPU 26 clears a registration content of the current position register RGSTp.

If a shutter button 28sh is half depressed, the CPU 26 executes a strict AE process based on output of the signal processing circuit 20. The CPU 26 performs the strict AE process on the applied Y data so as to calculate the appropriate EV value. An aperture amount and an exposure time defining the calculated appropriate EV value are set to the driver 18, and as a result, the brightness of the moving image is strictly adjusted.

Upon completion of the strict AE process, the CPU 26 performs an AF process on a high-frequency component belonging to a center of the scene, out of the Y data applied from the signal processing circuit 20. As a result, the focus lens 12 is arranged at a focal point, and thus, the sharpness of a through image is improved.

If the shutter button 28sh is fully depressed after the AF process is completed, a still image taking process and a recording process are executed. One frame of image data obtained when the shutter button 28sh is fully depressed is taken in the SDRAM 32 through the still image taking process. One frame of the taken image data is read out from the SDRAM 32 by an I/F 40 that is activated in association with the recording process, and is recorded on a recording medium 42 in a file format.

Using a plurality of image files continuously photographed at the same position from among two or more image files recorded in this way, the CPU 26 creates a group. With reference to FIG. 4, when a person HM continuously records scenes SC1 to SC6 shown in FIG. 4 by using the digital camera 10 while changing an angle at the same position, a plurality of image files which respectively record the scenes SC1 to SC6 configure the same group.

Hereinafter, an initially recorded image file out of a plurality of image files configuring one group will be referred to as a “leading image file”. The leading image file, for example, may include an image file initially recorded after a power source is applied, an image file initially recorded after a photographed position is changed. Furthermore, an image file, other than the leading image file out of the plurality of image files configuring one group, will be referred to as a “group image file”.

The CPU 26 determines whether an image file newly recorded corresponds to either the leading image file or the group image file in the following manner.

The latitude and the longitude registered in the current position register RGSTp are copied into a center position register RGSTc shown in FIG. 5, in response to the recording of the leading image file. Therefore, a registration content of the center position register RGSTc indicates a photographed position of the leading image file.

Furthermore, under the direction managing task activated according to the recording of the leading image file, the CPU 26 manages an imaging direction, that is, an inclination of the digital camera 10, based on output of a gyro sensor 48. The gyro sensor 48 detects whether or not a motion has occurred in the digital camera 10, and outputs a motion vector representing the detected motion if the occurrence of the motion is detected.

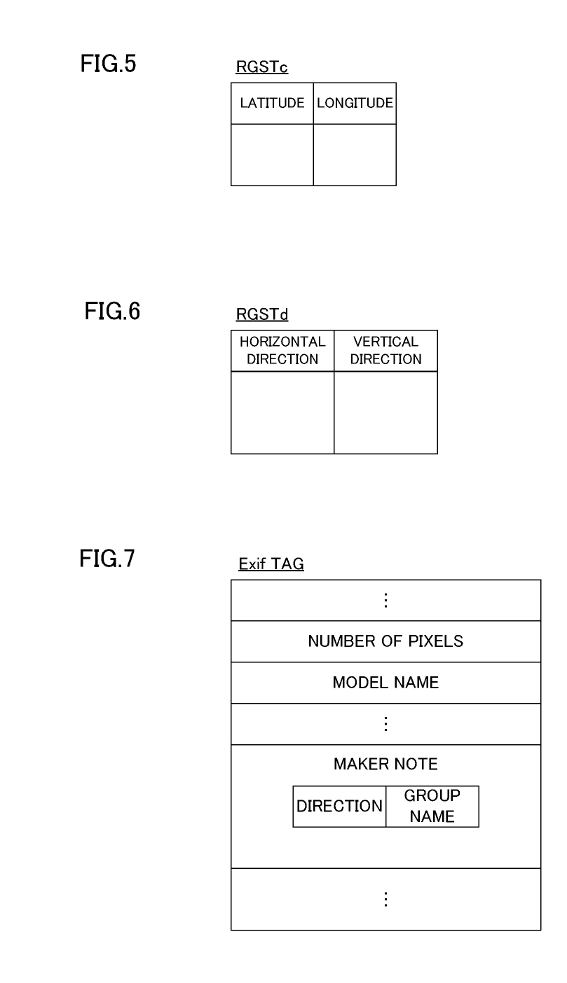

The motion vector outputted from the gyro sensor 48 is taken by the CPU 26. The CPU 26 calculates an inclination change amount of the digital camera 10 in each of a horizontal direction and a vertical direction based on the taken motion vector, and the calculated inclination change amounts are accumulated in a direction managing register RGSTd shown in FIG. 6.

The direction managing task is stopped and activated at each time a new leading image file is recorded, and therefore, the registration content of the direction managing register RGSTd is cleared at each time. Therefore, the registration content of the direction managing register RGSTd indicates a relative direction where an imaging direction at a time of photographing of the leading image file is used as a reference.

Furthermore, the CPU 26 executes a reset & a start of a timer 26t2 at each time the shutter button 28sh is fully depressed. For example, a timer value is 90 seconds.

According to the full depression of the shutter button 28sh after recording the leading image file, the position registered in the current position register RGSTp is compared with the position registered in the center position register RGSTc. As a result of the comparison, when the position registered in the current position register RGSTp is within a 30-m radius around the position registered in the center position register RGSTc, it is regarded that an image file newly recorded is continuously photographed at the same position as in an image file recorded immediately before. That is, the image file newly recorded is determined as a group image file of the same group as that of the image file recorded immediately before.

Meanwhile, when the position registered in the current position register RGSTp is out of the 30-m radius, the image file newly recorded is not determined as the group image file, but determined as the leading image file of a new group.

When the registration content of at least one of the current position register RGSTp and the center position register RGSTc is empty, that is, when the shutter button 28sh is fully depressed at a first time after the power source is applied or when the acquirement of the current position fails, it is not possible to compare the positions. In this case, it is determined whether or not a timeout occurs in the timer 26t2. When the timeout does not occur, the image file newly recorded is determined as the group image file of the same group as that of the image file recorded immediately before.

When the timeout occurs in the timer 26t2, that is, when a predetermined time period lapses since the immediately-before full depression of the shutter button 28sh, it is not regarded that the image file newly recorded is continuously photographed at the same position as in the image file recorded immediately before. Furthermore, the same applies when the timer 26t2 does not operate, that is, when the shutter button 28sh is fully depressed at a first time after the power source is applied. In these cases, the image file newly recorded is determined as the leading image file of a new group.

When it is determined that the image file newly recorded is determined as the group image file of the same group as that of the image file recorded immediately before, the CPU 26 acquires a current imaging direction with reference to the direction managing register RGSTd.

Next, the CPU 26 acquires a group name with reference to the recording medium 42. For the group name, for example, a file name of the leading image file is used.

Using the direction and the group name acquired in this way, the CPU 26 creates a header of the group image file. The inclination and the group name are written in a maker note of an Exif tag in the header as shown in FIG. 7. Using the header created in this way, the CPU 26 executes the above-described recording process.

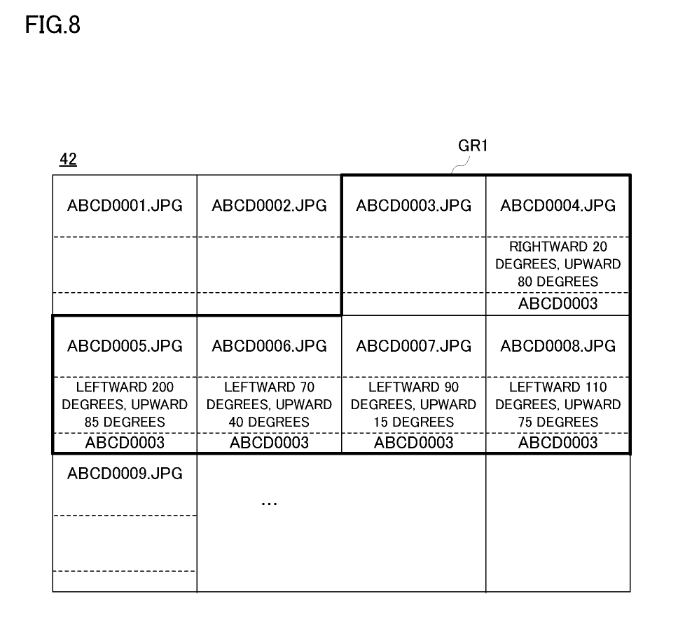

With reference to FIG. 8, six image files in which the scenes S1 to S6 shown in FIG. 4 are respectively recorded are accommodated in the recording medium 42 with the file names being ABCD0003.JPG to ABCD0008.JPG respectively. Therefore, the six image files ABCD0003.JPG to ABCD0008.JPG configure a group GR1. Furthermore, the ABCD0003. JPG indicates a leading image file of the group GR1, and each of the ABCD0004.JPG to ABCD0008.JPG indicates a group image file of the group GR1.

If the reproducing task is activated, the CPU 26 selects a latest image file recorded on the recording medium 42. The CPU 26 reads out image data of the selected image file from the recording medium 42 through the I/F 40, and writes the read-out image data in the SDRAM 32 through the memory control circuit 30. Furthermore, the CPU 26 instructs the LCD driver 36 to execute a reproducing process of the selected image file.

The LCD driver 36 reads out the image data accommodated in the SDRAM 32 through the memory control circuit 30, and drives the LCD monitor 38 based on the read-out image data. As a result, a still image is displayed on the LCD monitor 38.

If an update operation is performed by the key input device 28, the CPU 26 selects a succeeding image file or a preceding image file. The selected image file is subject to a reproducing process similar to that described above, and as a result, the display of the LCD monitor 38 is updated.

Furthermore, the CPU 26 searches other image files, which configure the same group as that of the selected image file, in the recording medium 42 at each time an image file is selected. If there is a description of the group name in the Exif tag of the selected image file, an image file with the Exif tag having the group name written therein and a leading image file indicated by the group name are searched. If there is no description of the group name in the Exif tag of the selected image file, an image file with the Exif tag having the file name of the selected image file written as a group name therein is searched.

When one or two or more image files configuring the same group are discovered, the CPU 26 converts a direction written in the Exif tag of each of the discovered image files to a relative direction where the direction written in the Exif tag of the selected image file is used as a reference. Furthermore, the CPU 26 creates a photographing direction table TBL using the converted direction.

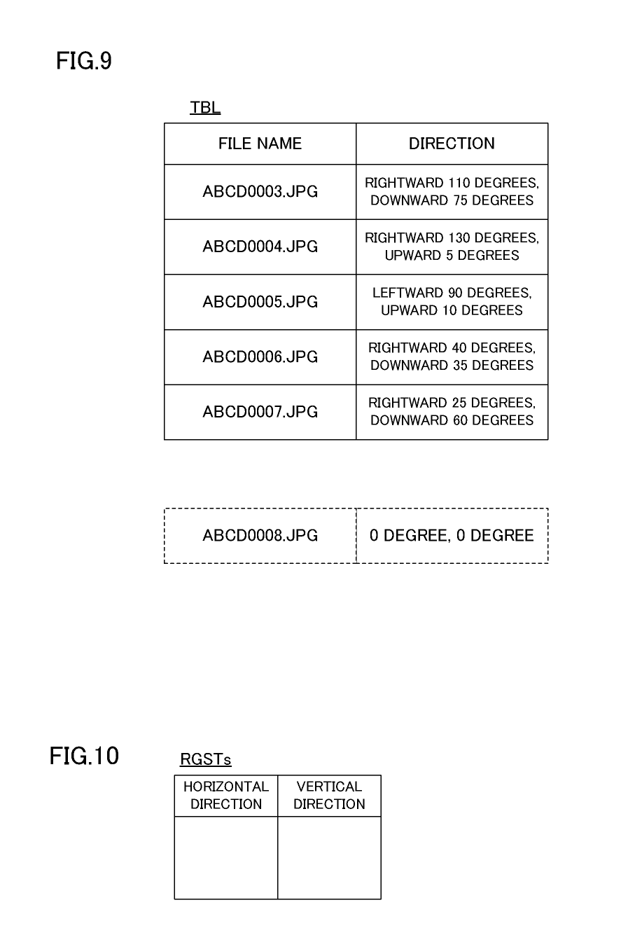

With reference to FIG. 9, the photographing direction table TBL is formed by columns in which the file name is written, and columns in which the converted direction is written. In a case in which the image file ABCD0008.JPG is selected when the recording medium 42 is in a recording state shown in FIG. 8, the image files ABCD0003.JPG to ABCD0007.JPG configuring the group GR1 are discovered. As a result, the photographing direction table TBL shown in FIG. 9 is created.

It is possible for an operator to designate a direction by inclining the digital camera 10 during the reproduction of the selected image file. When the digital camera 10 is inclined during the reproduction of the selected image file, a motion vector based on the inclination outputted from the gyro sensor 48 is taken by the CPU 26 under the reproducing task. The CPU 26 calculates an inclination change amount of the digital camera 10 in each of a horizontal direction and a vertical direction based on the taken motion vector.

The calculated inclination change amounts are accumulated in a designated-direction register RGSTs shown in FIG. 10 at each time the direction-designating operation is performed. Furthermore, the registration content of the designated-direction register RGSTs is cleared at each time an update operation is performed by the key input device 28. Therefore, the registration content of the designated-direction register RGSTs indicates a relative direction designated by a latest direction-designating operation where the direction written in the selected image file is used a reference.

Next, the CPU 26 reads out the photographing direction table TBL, and extracts a record in which a direction approximate to the designated direction registered in the designated-direction register RGSTs is written. The approximate direction, for example, includes a direction indicating a range of 20 degrees around the designated direction. When a plurality of records are discovered, a record indicating a direction closest to the designated direction is extracted.

An image file in which a file name is written in the extracted record is subject to a reproducing process similar to that described above. As a result, the display of the LCD monitor 38 is updated.

Then, if the direction-designating operation is performed, the designated-direction register RGSTs is updated, and an image file indicating a direction closest to the designated direction in the photographing direction table TBL is reproduced. Furthermore, if the update operation is performed by the key input device 28, an image file succeeding to the selected image file or an image file preceding thereto is reproduced.

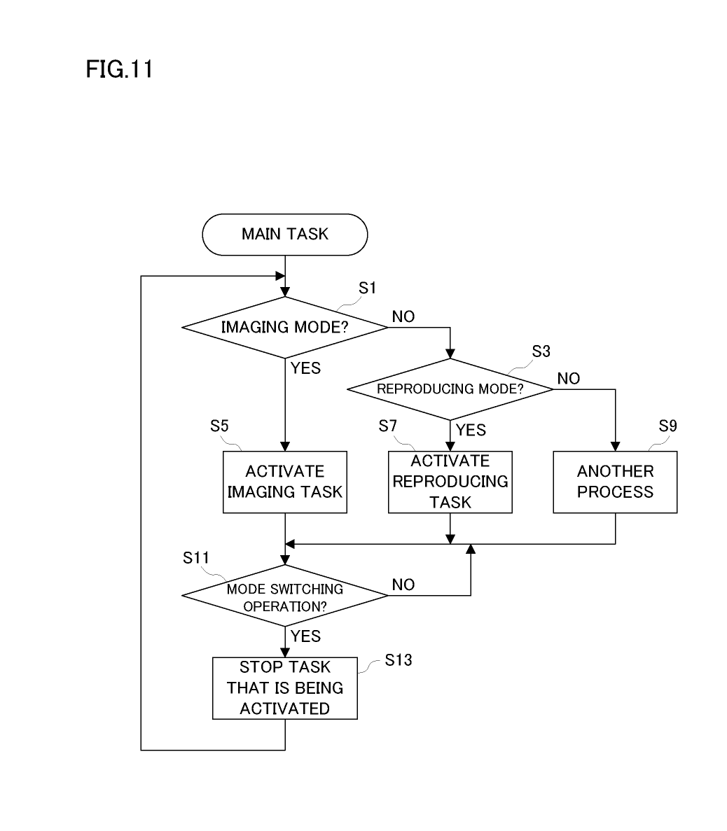

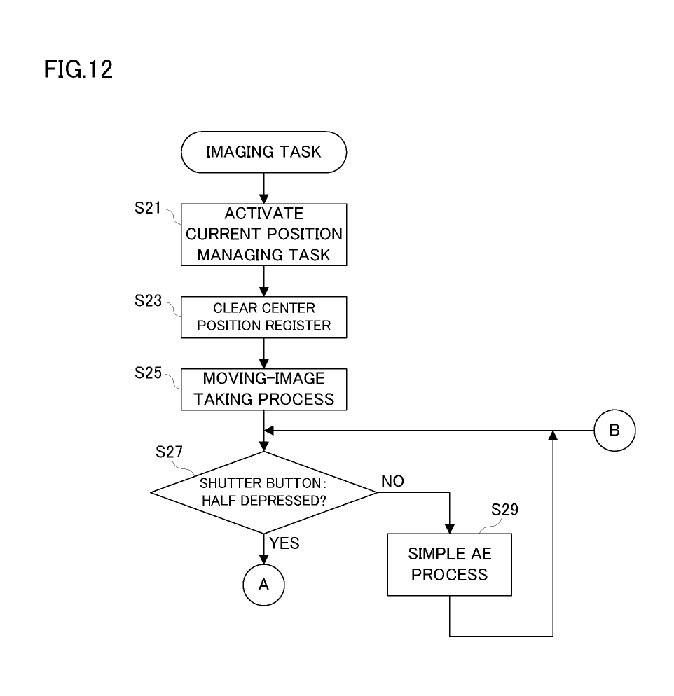

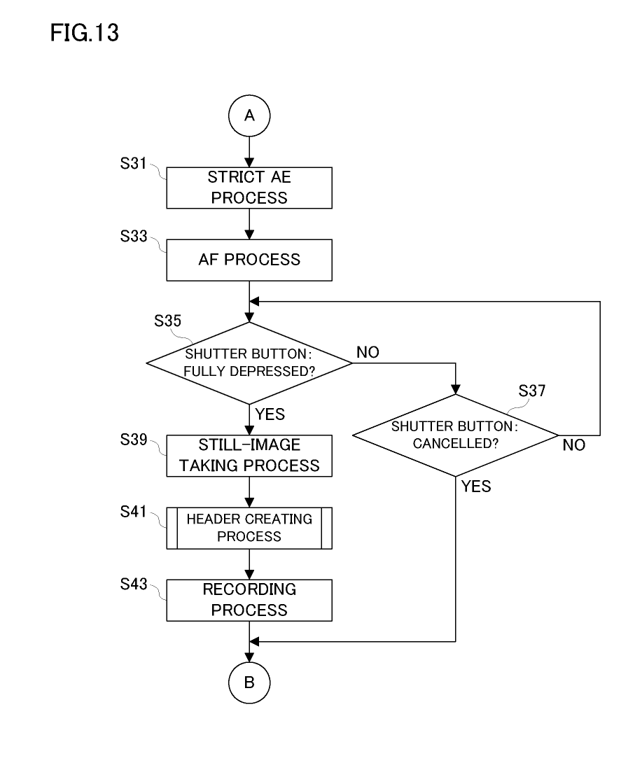

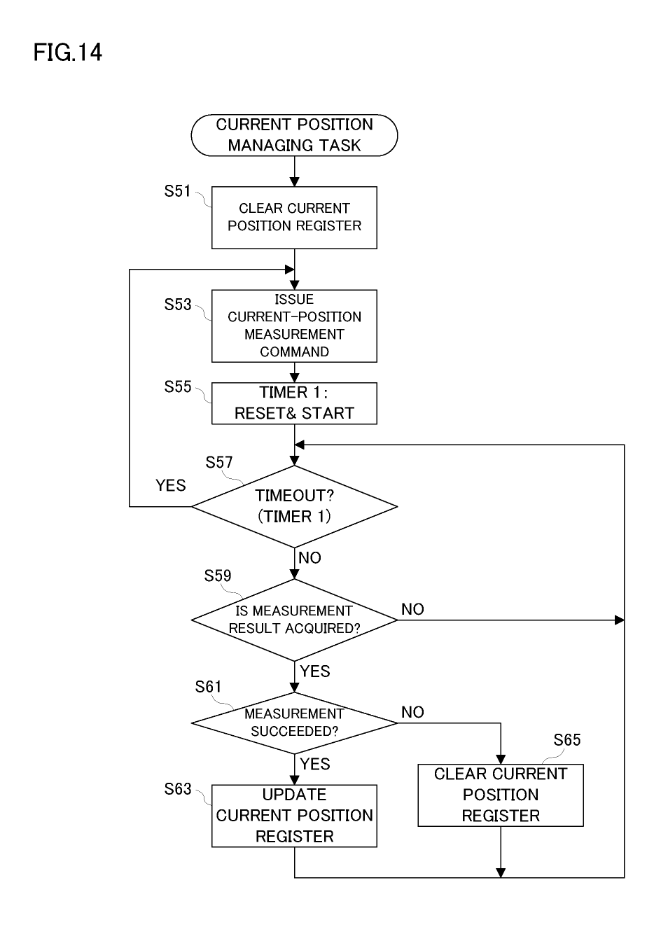

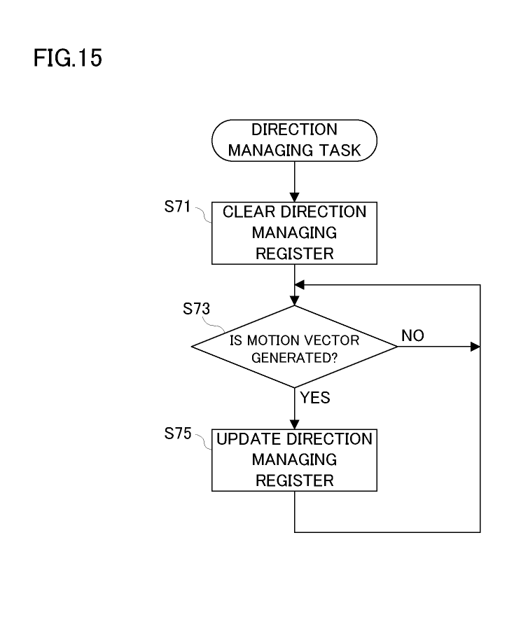

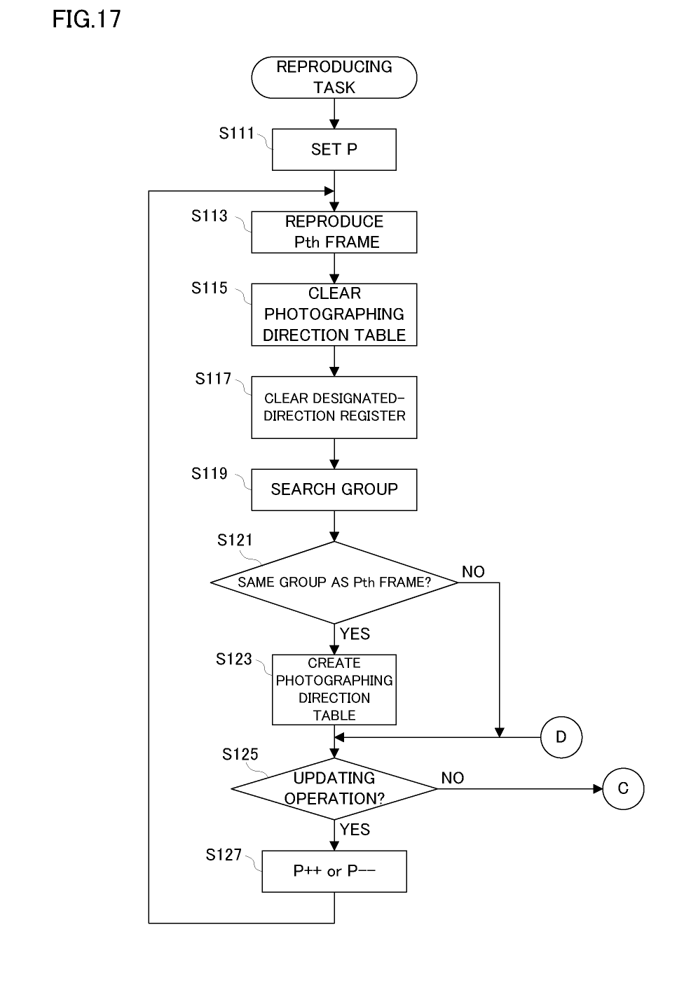

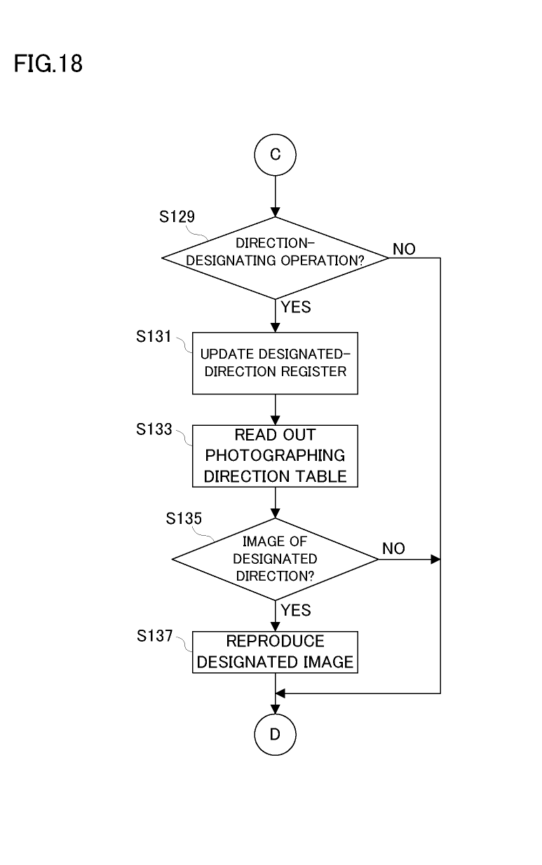

The CPU 26 executes a plurality of tasks including the main task shown in FIG. 11, the imaging task shown in FIGS. 12 and 13, the current position managing task shown in FIG. 14, the direction managing task shown in FIG. 15, and the reproducing task shown in FIGS. 17 and 18 in a parallel manner. It is noted that a control program corresponding to these tasks is stored in a flash memory 44.

With reference to FIG. 11, it is determined whether or not the operation mode at this time point is the imaging mode in a step S1, and determined whether or not the operation mode at this time point is the reproducing mode in a step S3. If YES is determined in the step S1, the imaging task is activated in a step S5, and if YES is determined in the step S3, the reproducing task is activated in a step S7. If NO is determined in the both steps S1 and S3, other processes are executed in a step S9. Upon completion of the process of the step S5, S7, or S9, it is repeatedly determined whether or not a mode switching operation is performed in a step S11. If the determined result is updated from NO to YES, a task being activated is stopped in a step S13, and then, the process returns to the step S1.

With reference to FIG. 12, the current position managing task is activated in a step S21, and the registration content of the center position register RGSTc is cleared in a step S23. A moving image taking process is executed in a step S25. As a result, a live view image representing a scene is displayed on the LCD monitor 38.

In a step S27, it is determined whether or not the shutter button 28sh is half depressed. If the determined result is NO, a simple AE process is executed in a step S29. The brightness of the through image is moderately adjusted by the simple AE process.

If the determined result of the step S27 is updated from NO to YES, a strict AE process is executed in a step S31. As a result, the brightness of the moving image is strictly adjusted. In a step S33, an AF process is performed. As a result, the focus lens 12 is arranged at a focal point, and thus, the sharpness of a live view image is improved.

In a step S35, it is determined whether or not the shutter button 28sh is fully depressed, and if the determined result is NO, it is determined whether or not the operation of the shutter button 28sh is released in a step S37. If the determined result of the step S37 is NO, the process returns to the step S35, and if the determined result of the step S37 is YES, the process returns to the step S27.

If the determined result of the step S35 is YES, a still mage taking process is executed in a step S39. As a result, one frame of image data, which represents a scene at a time point when the shutter button 28sh is fully depressed, is taken in the SDRAM 32.

In a step S41, a header creating process is executed, and a recording process using the header created in the step S41 is executed in a step S43. As a result, one frame of the taken image data is read out from the SDRAM 32 through the I/F 40 activated in association with the recording process, and is recorded on the recording medium 42 in a file format. Upon completion of the process of the step S43, the process returns to the step S27.

With reference to FIG. 14, the registration content of the current position register RGSTp is cleared in a step S51, and a measurement command of a current position is issued toward the GPS device 46 in a step S53. Reset & start of the timer 26t1 are executed in a step S55, and it is determined whether or not a timeout occurs in the timer 26t1 in a step S57. If the determined result is YES, the process returns to the step S53, and if the determined result is NO, the process proceeds to a step S59.

In the step S59, it is determined whether or not a measurement result of the current position is acquired, and if the determined result is NO, the process returns to the step S57 while if the determined result is YES, it is determined whether or not the measurement of the current position is succeeded in a step S61. If the determined result of the step S61 is YES, the process proceeds to a step S63, and if the determined result of the step S61 is NO, the process proceeds to a step S65.

The registration content of the current position register RGSTp is updated in the step S63, and the registration content of the current position register RGSTp is cleared in the step S65. Upon completion of the process of the step S63 or step S65, the process returns to the step S57.

With reference to FIG. 15, the registration content of the direction managing register RGSTd is cleared in a step S71, and it is repeatedly determined whether or not a motion vector is generated based on the output of the gyro sensor 48 in a step S73. If the determined result is updated from NO to YES, an inclination change amount based on the motion vector is accumulated in the direction managing register RGSTd in a step S75. Upon completion of the process of the step S75, the process returns to the step S73.

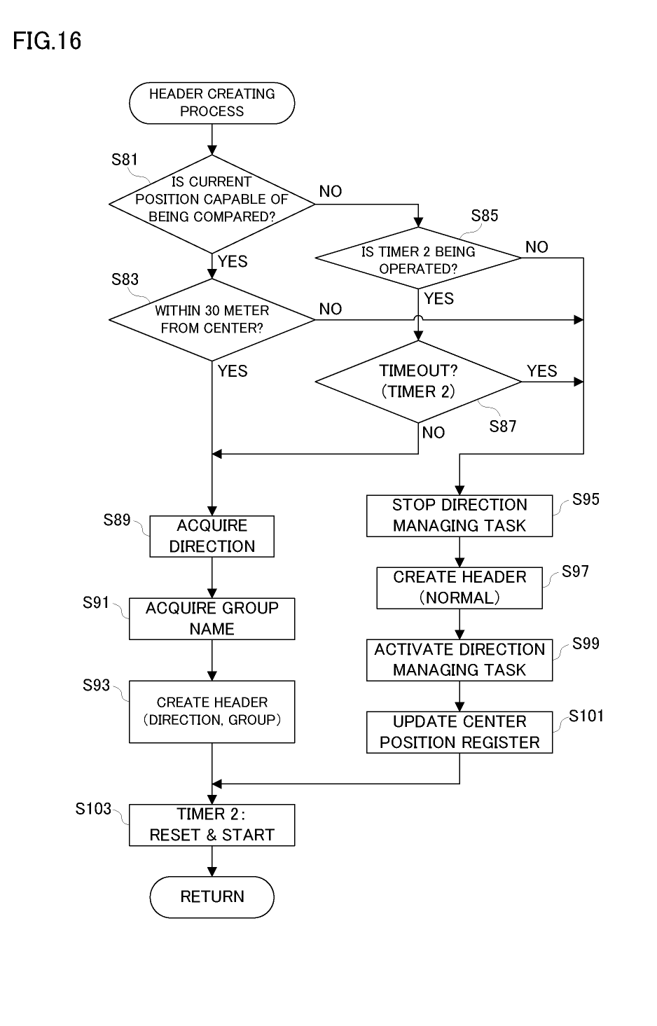

The header creating process of the step S41 is executed according to a sub-routine shown in FIG. 16. In a step S81, it is determined whether or not it is possible to compare the positions with reference to the registration content of the current position register RGSTp and the registration content of the center position register RGSTc. If the registration content of at least one of the registers is empty, the determined result is NO and the process proceeds to a step S85. If the positions are registered in the both registers, the determined result is YES and the process proceeds to a step S83.

In the step S83, it is determined whether or not the position registered in the current position register RGSTp is within a 30-m radius around the position registered in the center position register RGSTc. If the determined result is NO, the process proceeds to a step S95, and if the determined result is YES, the process proceeds to a step S89.

In the step S85, it is determined whether or not the timer 26t2 is being operated, and if the determined result is NO, the process proceeds to the step S95 while if the determined result is YES, it is determined whether or not a timeout occurs in the timer 26t2 in a step S87. If the determined result of the step S87 is YES, the process proceeds to the step S95, and if the determined result of the step S87 is NO, the process proceeds to the step S89.

In the step S89, a current imaging direction is acquired with reference to the direction managing register RGSTd. In a step S91, a group name is acquired with reference to the recording medium 42. For the group name, for example, a file name of the leading image file is used.

In a step S93, each of the direction acquired in the step S89 and the group name acquired in the step S91 is written in the maker note of the Exif tag in the header, and a header for an image file is created.

The direction managing task is stopped in the step S95, and a header for a normal image file is created in a step S97. The direction managing task is activated in a step S99, and in a step S101, the latitude and the longitude registered in the current position register RGSTp are copied and the center position register RGSTc is updated.

Upon completion of the process of the step S93 or step S101, reset & a start of the timer 26t2 is executed in a step S103, and then the process returns to the routine at a hierarchical upper level.

With reference to FIG. 17, a number indicating the latest image file is set to a variable P in a step S111, and an image file of a P-th frame recorded on the recording medium 42 is reproduced in a step S113.

In a step S115, a description of the photographing direction table TBL is cleared, and in a step S117, the registration content of the designated-direction register RGSTs is cleared.

In a step S119, other image files, which configure the same group as that of the image file of the P-th frame, are searched in the recording medium 42. If there is a description of a group name in the Exif tag of the selected image file, an image file with an Exif tag having the group name written therein and a leading image file indicated by the group name are searched. If there is no description of the group name in the Exif tag of the selected image file, an image file with an Exif tag having the file name of the selected image file written as a group name therein is searched.

In a step S121, it is determined whether or not other image files, which configure the same group as that of the image file of the P-th frame, are discovered, and if the determined result is NO, the process proceeds to a step S125 while if the determined result is YES, the process proceeds to the step S125 after performing the process of a step S123.

In the step S123, a direction written in an Exif tag of the discovered image file is converted to a relative direction where a direction written in the Exif tag of the image file of the P-th frame is used as a reference, and the photographing direction table TBL is created.

In the step S125, it is determined whether or not an operation for updating a reproduction file is performed by an operator, and if the determined result is YES, the variable P is incremented or decremented in a step S127, and the process returns to the step S113. If the determined result is NO, the process proceeds to a step S129.

In the step S129, it is determined whether or not there is a direction-designating operation by the inclination of the digital camera 10, and if the determined result is NO, the process returns to the step S125 while if the determined result is YES, the process proceeds to a step S131.

In the step S131, an inclination change amount in each of a horizontal direction and a vertical direction by the direction-designating operation is accumulated, and the registration content of the designated-direction register RGSTs is updated. In a step S133, the photographing direction table TBL is read out, and a record indicating a direction approximate to the designated direction registered in the designated-direction register RGSTs is searched.

In a step S135, it is determined whether or not there is a record corresponding to the direction approximate to the designated direction, and if the determined result is NO, the process returns to the step S125 while if the determined result is YES, an image file with a file name written in the discovered record is reproduced in a step S137. Upon completion of the process of the step S137, the process returns to the step S125.

As apparent from the above description, the CPU 26 records the image outputted from the image sensor 16 in response to the recording operation, and assigns an imaging direction at a time of accepting the recording operation to the recorded images. Furthermore, the CPU 26 executes a process for extracting one portion of the images having a common imaging position from among the plurality of recorded images in response to the reproducing operation, and accepts the direction-designating operation in association with the extracting process. The CPU 26 reproduces an image, to which an imaging direction equivalent to a direction designated by the direction-designating operation is assigned, from among one portion of the extracted images.

The imaging direction at a time of accepting the recording operation is assigned to the recorded images. One portion of the images having a common imaging position is extracted from among the plurality of recorded images in response to the reproducing operation. Among one portion of the extracted images, an image, to which the imaging direction equivalent to the direction designated by the direction-designating operation accepted in association with the extracting process is assigned, is reproduced.

As described above, a reproduced image is determined by a combination of the imaging direction assigned to the image and the direction-designating operation. Therefore, it is possible to determine a reproduced image through an operation simpler than a normal selecting operation, and this serves to improve operability at a time of selecting a reproduced image.

It is noted that in this embodiment, the imaging direction is calculated based on the output of the gyro sensor 48. However, the imaging direction may be calculated based on the Y data outputted from the signal processing circuit 20, or the two calculation methods may be used together.

Furthermore, in this embodiment, the direction-designating operation is performed when an operator inclines the digital camera 10 at a time of reproducing an image. However, the direction-designating operation may be performed by the key input device 28.

Furthermore, in this embodiment, a group is created at a time of recording an image. However, an imaging position may be recorded in a header of an image file and the group may be created at a time of reproducing an image.

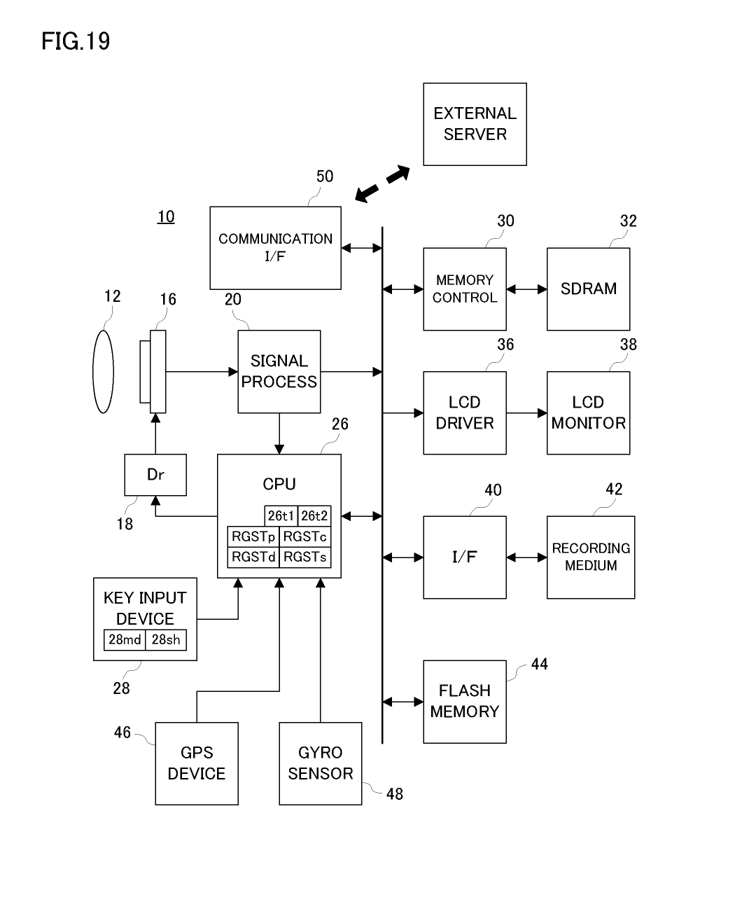

Furthermore, in this embodiment, a multi-task OS and the control program equivalent to a plurality of tasks executed by this are stored in the flash memory 44 in advance. However, a communication I/F 50 for a connection to an external server may be provided in the digital camera 10 as shown in FIG. 19, a partial control program may be prepared in the flash memory 44 as an internal control program from the beginning, and another partial control program may be acquired as an external control program from an external server. In this case, the above-described operations are implemented by the cooperation of the internal control program and the external control program.

Furthermore, in this embodiment, the process executed by the CPU 26 is divided into a plurality of tasks including the main task, the imaging task, the current position managing task, the direction managing task, and the reproducing task shown in FIG. 11 to FIG. 18. However, these tasks may be further divided into a plurality of smaller tasks, and furthermore, one portion of the plurality of divided smaller tasks may be integrated with other tasks. Furthermore, when a transfer task is divided into a plurality of smaller tasks, the whole or one portion of the transfer task may be acquired from an external server.

Furthermore, this embodiment is described using a digital still camera. However, the present invention can be applied to a digital video camera, a cellular phone, a smart phone, and the like.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
a recorder which records an image outputted from an imager in response to a recording operation;
an assigner which assigns an imaging direction at a time of accepting the recording operation to the image recorded by said recorder,
an extractor which executes, in response to a reproducing operation, a process for extracting one portion of images having a common imaging position from among a plurality of the images recorded by said recorder,
an acceptor which accepts a direction-designating operation in association with the extracting process of said extractor, and
a reproducer which reproduces an image, to which an imaging direction equivalent to a direction designated by the direction-designating operation is assigned, from among the one portion of images extracted by said extractor.

2. An electronic camera according to claim 1, further comprising:
a detector which continuously detects a change in the imaging direction; and
an activator which stops the process of said assigner when the image recorded by said recorder is equivalent to a reference image that satisfies a predetermined condition, and activates said detector, wherein said assigner executes an assigning process with reference to a detection result of said detector.

3. An electronic camera according to claim 2, wherein the predetermined condition includes at least one of a distance condition in which a distance from an imaging position of the image recorded by said recorder last time exceeds a first reference, and a time condition in which a time from an imaging time of the image recorded by said recorder last time exceeds a second reference.

4. An electronic camera according to claim 2, wherein the one portion of images extracted by said extractor is equivalent to an image group starting from the reference image, and said electronic camera further comprising an image reproducer which initially reproduces either one of the images belonging to the image group, in response to the reproducing operation.

5. An electronic camera according to claim 4, further comprising a converter which converts an imaging direction, which is assigned to the one portion of images extracted by said extractor, to a direction where a posture of a camera housing at this time point is used as a reference, wherein said reproducer executes a reproducing process with reference to the direction converted by said convertor.

6. An image processing program, which is recorded on a non-temporary recording medium in order to control an electronic camera including an imager, allowing a processor of the electronic camera to execute:
a recording step of recording an image outputted from said imager in response to a recording operation;
an assigning step of assigning an imaging direction at a time of accepting the recording operation to the image recorded in said recording step;
an extracting step of executing a process for extracting one portion of images having a common imaging position from among a plurality of the images recorded in said recording step in response to a reproducing operation;
an accepting step of accepting a direction-designating operation in association with the extracting process of said extracting step; and
a reproducing step of reproducing an image, to which an imaging direction equivalent to a direction designated by the direction-designating operation is assigned, from among the one portion of images extracted in said extracting step.

7. An image processing method, which is executed by an electronic camera including an imager, comprising:
a recording step of recording an image outputted from said imager in response to a recording operation;
an assigning step of assigning an imaging direction at a time of accepting the recording operation to the image recorded in said recording step;
an extracting step of executing a process for extracting one portion of images having a common imaging position from among a plurality of the images recorded in said recording step in response to a reproducing operation;
an accepting step of accepting a direction-designating operation in association with the extracting process of said extracting step; and
a reproducing step of reproducing an image, to which an imaging direction equivalent to a direction designated by the direction-designating operation is assigned, from among the one portion of images extracted in said extracting step.
